(19) United States
(12) Patent Application Publication
(10) Pub. No.: US 2023/0360318 A1
(43) Pub. Date: Nov. 9, 2023

(54) VIRTUAL VIEW GENERATION

(71) Applicant: CREATEC ROBOTICS LIMITED, Oxford (GB)

(72) Inventors: Matthew Paul Mellor, Cockermouth (GB); Benjamin Omar Chaudhri, Cockermouth (GB)

(73) Assignee: CREATEC ROBOTICS LIMITED, Oxford (GB)

(21) Appl. No.: 17/922,948

(22) PCT Filed: Apr. 26, 2021
(86) PCT No.: PCT/GB2021/051003

§ 371 Date: Nov. 2, 2022

(30) Foreign Application Priority Data
May 4, 2020 (GB) 2006544.7

(51) Int. Cl. G06T 15/20; G06T 15/40

(52) U.S. Cl. CPC G06T 15/205; G06T 15/405; G06T 2210/08

(57) ABSTRACT

Disclosed herein is a system for generating a virtual view by each of one or more viewer nodes, the system comprising: a plurality of source nodes, wherein each source node is a source of a 3D data stream; a plurality of intermediate nodes, wherein each intermediate node is arranged to receive a 3D data stream from one or more of the source nodes and to generate a virtual 3D data stream in dependence on each received 3D data stream; and one or more viewer nodes, wherein each viewer node is arranged to receive a virtual 3D data stream from each of one or more intermediate nodes and to generate a virtual view in dependence on each received virtual 3D data stream.

### FIELD

The field of the invention is the generation of a virtual view from source nodes of 3D data. Embodiments provide a modular and scalable network of intermediate nodes between source nodes of 3D data and a plurality of viewer nodes where virtual views are generated. Advantageously, the network of intermediate nodes allows a large number of viewer nodes to be supported for a given reception bandwidth of each viewer node.

### BACKGROUND

Technologies such as virtual reality and augmented reality are increasingly finding applications in industry. In many applications, using real-time 3D data is an essential component of the system, particularly where monitoring or control of a remote location is required; a family of applications often described as ‘telepresence’. There are several types of real-time 3D sensor that can be used for telepresence, but they all share a common characteristic of producing high data rates. This represents a challenge for telepresence applications where the real-time data must typically be transported over a network with bandwidth limitations. The challenge is further compounded by the fact that it is typically necessary to use multiple 3D sensors in many applications.

There is a general need to improve the provision of virtual viewing systems.

### SUMMARY

According to a first aspect of the invention, there is provided a system for generating a virtual view by each of one or more viewer nodes, the system comprising: a plurality of source nodes, wherein each source node is a source of a 3D data stream; a plurality of intermediate nodes, wherein each intermediate node is arranged to receive a 3D data stream from one or more of the source nodes and to generate a virtual 3D data stream in dependence on each received 3D data stream; and one or more viewer nodes, wherein each viewer node is arranged to receive a virtual 3D data stream from each of one or more intermediate nodes and to generate a virtual view in dependence on each received virtual 3D data stream.

Preferably, the system comprises a networked arrangement of one or more layers of intermediate nodes between a plurality of sources nodes and one or more viewer nodes.

Preferably, at least one of the intermediate nodes is arranged to receive a virtual 3D data stream from each of a plurality of other intermediate nodes; and said at least one of the intermediate nodes is arranged to generate and output a virtual data stream in dependence on a combination of the received virtual 3D data streams.

Preferably, each source node comprises one or more of: a 3D sensor that is arranged to generate a 3D data stream of substantial real-time data measurements; a source of a simulated 3D data stream; and a source of recorded 3D data stream.

Preferably, each source node is a source of a 3D data stream that comprises 3D images; and, optionally, the 3D images are RGB-D images.

Preferably: the virtual 3D data stream generated by each intermediate node is a virtual depth image; each virtual depth image includes at least one depth channel; and each viewer node is arranged to generate a virtual view in dependence on a combination of virtual depth images received from a plurality of intermediate nodes; wherein, optionally, each virtual depth image is a virtual RGB-D image.

Preferably: the generation of a virtual view comprises performing a z-culling of occluded points; and the virtual view is one or more of a 2D image display, a virtual reality display and data that may interpreted by a machine learning/artificial intelligence system, such as for image recognition techniques.

Preferably: each viewer node is arranged to send a view point request to one or more intermediate nodes and/or one or more source nodes; and each view point request is a request for data required for generating a virtual view; wherein, optionally, each virtual depth image generated by an intermediate node is generated in response to a received view point request.

Preferably, each virtual depth image generated by an intermediate node substantially only comprises data for use in generating a virtual view corresponding to a received view point request.

Preferably, the system comprises a plurality of viewer nodes.

Preferably, the system is scalable such that one or more source nodes, intermediate nodes and viewer nodes may be added to, or removed from, the system.

Preferably, at least some of the intermediate nodes are provided in a cloud computing system.

Preferably, each source node has a transmission bandwidth for transmitting a 3D data stream; and the required bandwidth by each viewer node for receiving one or more 3D data streams is substantially the same as, or less than, the transmission bandwidth of the source node with the largest transmission bandwidth.

Preferably, the input bandwidth of each intermediate node is substantially the same as the output bandwidth of each intermediate node.

Preferably, one or more of the source nodes and/or one or more of the intermediate nodes are arranged to compress 3D data streams prior to their transmission.

Preferably, the system further comprises a source support unit that is arranged to support a plurality of the source nodes; and the relative geometry between said plurality of source nodes is dependent on the source support unit; wherein, optionally, all of said plurality of source nodes are arranged to transmit a 3D data stream to the same intermediate node; and wherein, optionally, the intermediate node that said plurality of sources nodes transmit a 3D data stream to is supported by the source support unit.

Preferably the system further comprises a controller that is arranged to transmit a global clock message to each of the source nodes and/or intermediate nodes; wherein the transmission of data from the source nodes and/or intermediate nodes is dependent on the global clock message.

Preferably, the controller is one of the intermediate nodes.

Preferably, in response to a view point request from a viewer node, one or more of the intermediate nodes are arranged to transmit a plurality of virtual depth images to a viewer node; and the plurality of transmitted virtual depth images are at least two sides of a sky cube.

Preferably: the number of source nodes is between 1 and 1000; and/or the number of intermediate nodes is between 1 and 1000.

Preferably, the number of viewer nodes is between 1 and 1000.

Preferably, the number of data streams input to one of the intermediate nodes is different from the number of data streams input to another one of the intermediate nodes.

According to a second aspect of the invention, there is provided a method of generating a virtual view by each of one or more viewer nodes, the method comprising: generating, by each of a plurality of source nodes, a 3D data stream; receiving, by each of a plurality of intermediate nodes, a 3D data stream from one or more of the source nodes and generating a virtual 3D data stream in dependence on each received 3D data stream; and receiving, by one or more viewer nodes, a virtual 3D data stream from each of one or more intermediate nodes and generating a virtual view in dependence on each received virtual 3D data stream.

Preferably, the method is implemented in a system according to the first aspect.

According to a third aspect of the invention, there is provided a computer program product that, when executed by a computing system, is arranged to cause the computing system to perform the method according to the second aspect.

### LIST OF FIGURES

FIG. 1 shows an arrangement of a plurality of source nodes in a scene comprising objects according to an embodiment;

FIG. 2 is a schematic diagrams of a network of nodes, or part of a network of nodes, according to an embodiment;

FIG. 3 is a schematic diagrams of a network of nodes, or part of a network of nodes, according to an embodiment;

FIG. 4 is a schematic diagrams of a network of nodes, or part of a network of nodes, according to an embodiment;

FIG. 5 is a schematic diagrams of a network of nodes, or part of a network of nodes, according to an embodiment;

FIG. 6 is a schematic diagram of a cloud based system according to an embodiment; and

FIG. 7 shows a sky cube according to an embodiment.

### DESCRIPTION OF EMBODIMENTS

Embodiments provide an improved data processing system, that may be a virtual viewing system, over known techniques. The data processing system comprises a network of nodes for obtaining and processing 3D data streams prior to providing the data streams to viewer nodes where virtual views are generated.

The data processing system according to embodiments may be modular and arbitrarily scalable. It may support both a large number of source nodes, that each output a 3D data stream, and a large number of viewer nodes, that each generate a virtual view in dependence on data from the source nodes. Within the system, the maximum required transmission bandwidth may be proportional to the lesser of the number of users or the number of sensors.

The maximum receive bandwidth may be substantially the same as the transmission bandwidth of a single sensor.

Throughout the present document, the following terms are used:

Source node—A source node may be, for example, a sensor module that comprises a 3D vision sensor that is connected to a computing system for outputting a 3D data stream of visual data. A source node may alternatively output a 3D data stream of simulated visual data and/or a 3D data stream of recorded visual data the source nodes are leaf nodes in the network.

3D vision sensor—A 3D vision sensor is device that records the depth and/or intensity/colour of points within its field of view. A 3D vision sensor generates data for providing a 3D reconstruction of points in a scene. Examples include RGB-D sensors, such as the Microsoft Kinect.

Intermediate node—An intermediate node is a computing system that receives a 3D data stream from one or more source nodes and/or other intermediate nodes, and outputs data to one or more viewer nodes and/or other intermediate nodes. Each intermediate node is provided in a data pipeline through the network between at least one source node and at least one viewer node.

Viewer node—A viewer node is a computing system that requests and receives data for providing a view point (i.e. that of a viewer) in a scene. The request may be sent to, and received from, intermediate nodes. The received data for providing a view point may be displayed as a 2D image, displayed to a human in a virtual reality environment and/or interpreted by a machine learning/artificial intelligence system, for example for image recognition purposes.

A cluster node—A cluster node is a type of intermediate node that receives 3D data streams only from a plurality of source nodes.

Viewer—A viewer receives 3D data stream of visual data corresponding to a view point in the scene that can be displayed to a human which is processed before display on a VR display or screen.

Scene—A scene is a physical environment that comprises sources nodes. For example, a scene may comprise objects that are in the field of view of 3D vision sensors.

Virtual depth image—A virtual depth image is a synthesised RGB-D image.

Virtual sensor—A virtual sensor is a data stream of virtual depth images constructed in dependence on the received data streams by an intermediate node. The virtual sensor has a view point. The virtual depth images of a virtual sensor may correspond to images that would be obtained by source node if the source node was positioned in the scene so as to have the virtual view point of the virtual sensor.

Embodiments are described in more detail below.

Embodiments provide a data processing system for processing and combining the data from an arbitrary number of source nodes, such as 3D vision sensors that may be RGB-D sensors or lidars, looking on a scene to produce views of the scene to an arbitrary number of viewers from any arbitrary point of view in the scene. The viewers may be, for example, human users that need to view the scene from view points that may differ from the view points of the source nodes. The viewers may alternatively be automated, as may be required in an image recognition system.

The remote perception of a scene is conventionally achieved with camera video feeds. It is also possible to use 3D vision sensors which produce a depth map of points visible to the sensor which are then colourised. The data may then be displayed to a person as a 3D point cloud which may then be rendered on a display device such as a monitor or VR display. To achieve a full view of a scene, without blindspots, multiple 3D vision sensors are required that view objects from different viewpoints.

A known technique for displaying 3D scene data to a viewer is to transmit all points in the scene recorded by 3D vision sensors to a graphics engine which then renders a visual representation of the scene from the desired viewpoint of the viewer.

A problem with this known technique is that 3D vision sensors output data at very high rates and it can be very difficult, or not possible, to meet the bandwidth and computational resource requirements. When a large number of 3D vision sensors are used then the required bandwidth to transmit all of the data generated by each of the 3D vision sensors to each graphics engine is very large. In addition, each graphics engine requires a large amount of computational resources in order to be able to process the received data with low latency, as is required in substantial real-time remote perception applications.

Embodiments provide a data processing system that can support a large number of source nodes and viewer nodes with substantially lower bandwidth and computational resource requirements than with known techniques.

The data processing system according to embodiments comprises a network of nodes. Data is generated a source nodes and passes through intermediate nodes and onto viewer nodes. The intermediate nodes that data passes through provide a pipeline in which the data may be processed.

Typical applications of embodiments are the perception (by human or machine) of live, i.e. substantial real-time, 3D data streams from multiple data sources. Applications include, but are not limited to, 3D surveillance of areas for security purposes, inspection and monitoring of infrastructure or processes, the visualisation of a scene to aid the tele-operation of robotics systems, and telepresence applications.

The 3D data streams used in embodiments may be depth images. A depth image is a standard output of a class of 3D sensors called RGB-D cameras. A depth image output from a RGB-D camera is a 4-channel image. The first three channels are the red, green and blue channels of a conventional digital image (although they could also be used to represent other quantities associated with a points in 3D such as infrared, heat, radioactivity). The fourth channel represents ‘depth’; this distance from the camera center to the imaged object at each pixel. Knowing the field of view of the camera, it is then possible to calculate the 3D position in space of each pixel using trigonometry, enabling the image to be displayed as a cluster of 3D dots that are a 3D mesh. A 3D mesh can be digitally rendered from other angles using readily available computer algorithms and software. This can be used to create virtual images from other view points than that of the RGB-D camera that took the depth image.

Embodiments use virtual depth images. A virtual depth image may be produced using the same process by which a 3D image can be rendered from 3D points into a 2D view, but augmented to also record a depth channel. The depth channel (sometimes referred to as a Z buffer) is commonly also constructed when rendering 2D images from 3D images in order to be able to represent occlusion correctly, but is generally discarded afterwards. A virtual depth image is rendered in the same way as a conventional 2D projection, but retaining the depth channel.

It is standard for virtual depth images to be linear projections. That is to say, the pixel coordinates in a virtual depth image of a particular point in 3D space can be represented by a matrix multiplication. However, embodiments also include the use of virtual depth images that are non-linear projections. For example, fisheye or equirectangular projections can also be used and may have advantages in VR applications where it may be desirable to represent a wider field of view than can be achieved with a linear projection.

The following notation is used throughout the description of embodiments:

D_{n,m} is the m^{th} frame of data from the n^{th} source node. Each source node may be, for example a 3D sensor such as a RGB-D camera.

Pₙ( ) is a reconstruction function that converts the raw data of the n^{th} source node into a metric 3D space with an ‘intrinsic’ coordinate system. Software that embodies Pₙ( ) may be provided a standard with a commercially available source node. The output of Pₙ(D_{n,m}) is a list of coordinates representing points in 3D space, optionally with attributes for each point, such as colour.

T_{n,m} ( ) is a translation and rotation transform that represents the location and attitude of a source node in a common coordinate system that is shared by other source nodes and the users, i.e the viewer nodes. Source nodes may move over time, so can vary with frame reference, m, as well as sensor ID, n. The inverse transform, which takes points in the shared coordinate system and returns them to the intrinsic coordinate frame of the nth sensor is denoted T_{n,m}⁻¹( ).

T_{v,m} ( ) is a transform that represents the location and attitude of the v^{th} virtual depth sensor, i.e. a virtual camera. A virtual depth sensor uses data from source nodes to provide a depth image, that is a virtual depth image, that may be from a different view point of any of the source nodes.

V( ) is a projection function that produces a virtual depth image, given a list of 3D points and associated data in the intrinsic coordinate system of the virtual depth sensor.

D_{v,n,m} is the m^{th} frame of data from the v^{th} virtual depth sensor, constructed using only the n^{th} 3D sensor.

D_{v,m} is the m^{th} frame of data from the v^{th} virtual depth sensor constructed using all relevant 3D sensor inputs.

The process of generating the output of a single virtual depth sensor in a system comprising a single 3D sensor can be represented by:

D_{v,1,m}=V(T_{v,m}⁻¹(T_{1,m}(P₁(D_{1,m})))) Eq. 1

Embodiments can generate depth images in dependence on data from more than one source node by using Eq. 1 to produce virtual depth images for each source node and then combining the virtual depth images. For example, when there are two source nodes, a new combined depth image can be generated as:

D_{v,m}=D_{v,1,m}+D_{v,2,m} Eq. 2

In Eq. 2, the ‘+’ operator denotes the combination of two frames. The process used to combine the two frames is not addition. The process used to combine the two frames is an algorithm that enforces occlusion. There are many known algorithms that may be used in embodiments to enforce occlusion, some of which are disclosed below.

Efficient virtual view rendering by merging pre-rendered RGB-D data from multiple cameras, by Yusuke Sasaki and Tadahiro Fujimoto, IEEE, 2018 International Workshop on Advanced Image Technology (IWAIT), 7-9 Jan. 2018, Chiang Mai, Thailand, INSPEC Accession Number: 17806389, DOI: 10.1109/IWAIT.2018.8369699, pp. 1-4, discloses a technique for transmitting data from two RGB-D cameras to a single user. This paper is referred herein as the Sasaki paper.

In the Sasaki paper, a single virtual depth camera is created with transform T_{v,m}( )=T_{u,m}( ), where T_{u,m}( ) represents the current location and viewing direction of the user (this may, for example, be the position and attitude of a VR headset). Prior to transmission, the depth images from each camera are combined by applying Eqs. 1 and 2, so that a single depth image is sent. The Sasaki paper is therefore a disclosure of an efficient way of connecting two source nodes to a single user by combining data from the source nodes on the transmit side using a virtual depth sensor.

Limitations of the method in the Sasaki paper include it not disclosing an efficient method for multiple users, i.e. viewer nodes, to access the same source nodes, and it having a single centralised processing node, which places a practical limit on the number of sensors that can be processed.

Embodiments provide a new multi-layered network architecture. The operation of nodes within the network is based on the virtual depth sensor concept. The required processing is distributed over a plurality of nodes. Each node receives and transmits data streams of a number of real and/or virtual depth sensors, with the maximum number of received and transmitted data streams defined by the network architecture. The distributed processing by intermediate nodes within the network allows the network architecture to be flexible. The network can therefore be extended to include more nodes, or the number of nodes can be reduced. The network can support a large number of source nodes and a large number of viewer nodes with the bandwidth and processing requirements at each node being a lot less restrictive than with known techniques.

The network according to embodiments comprises source nodes, intermediate nodes and viewer nodes. Each node within the network may be referred to as a processing node. Each processing node may receive up to N input data streams and may export up to M data streams. Each data stream is a data stream from a real or virtual depth sensor. Both N and M are defined by the network architecture with N+M>0 and M may be greater than N. The network is defined by a plurality of layers of nodes. The input layer, or source node layer, comprises only source nodes and therefore has one node per data source. The output layer, or viewer node layer, comprises only viewer nodes, i.e. one node per user. In the source node layer, each node outputs data only. Each source node may transmit the data that they generate to up to M receiving nodes. In the viewer node layer, the nodes only receive data only. Each viewer node may receiver data from N transmitting nodes.

It should be noted that even though each processing node may receive up to N input data streams and may export up to M data streams, the values of M and N may vary between nodes. For example, a network may include some small nodes may be capable of receiving up to 3 data streams and outputting up to 3 data streams, and the same network may include some large nodes may be capable of receiving up to 1000 data streams and outputting up to 1000 data streams.

The network may be reconfigurable so that any node in the network may be configured send/receive multiple outputs/inputs to/from any other node.

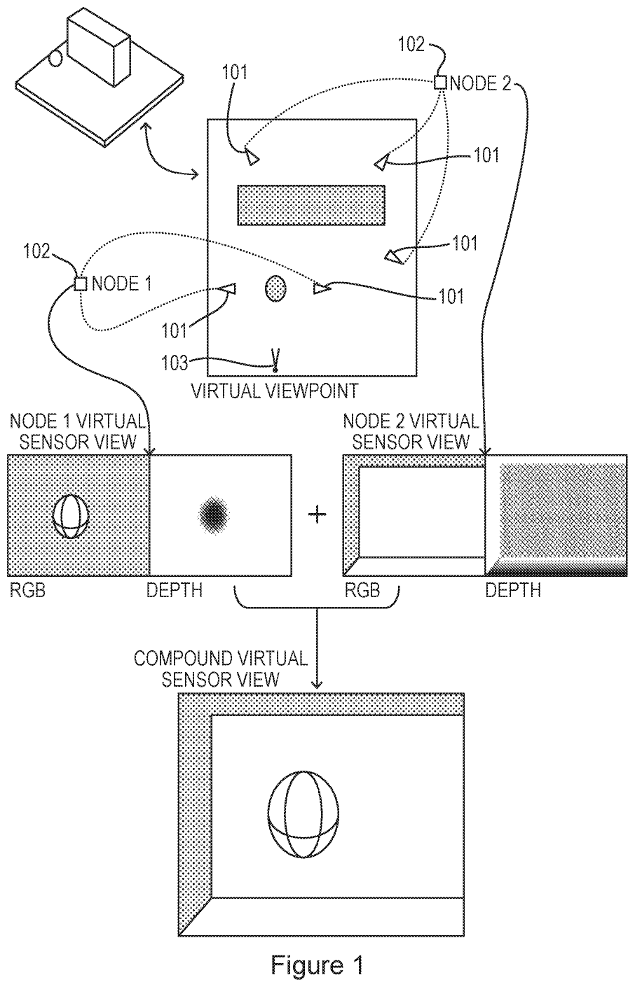

FIG. 1 shows an arrangement of a plurality of source nodes 101 in a scene comprising objects according to an embodiment. Each source node generates a 3D data stream of RGB-D data. These are transmitted to at least one viewer node via a network of intermediate nodes 102. At least one viewer node generates a virtual reality view of the scene, that corresponds to a view point 103, in dependence on at least some of the generated 3D data streams.

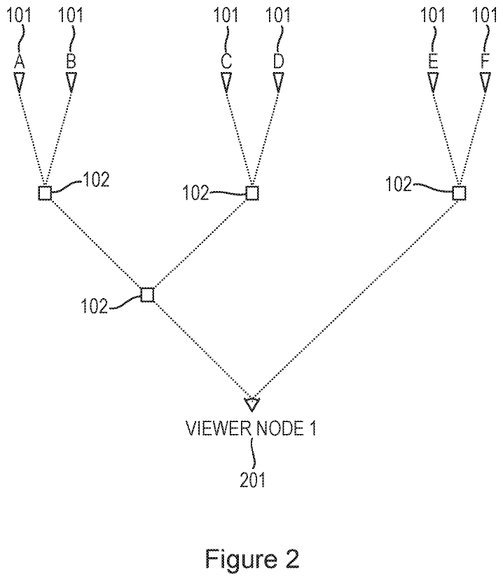

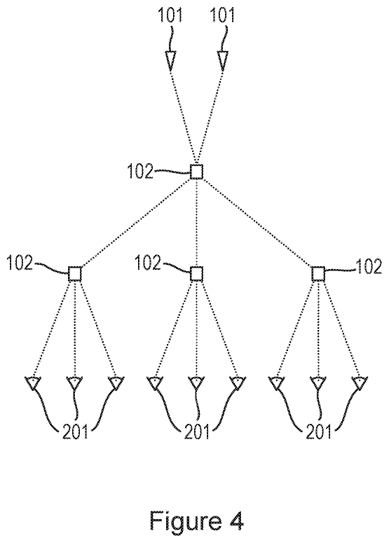

FIGS. 2, 3, 4, 5 and 6 are schematic diagrams of networks of nodes, or parts of networks of nodes, according to embodiments.

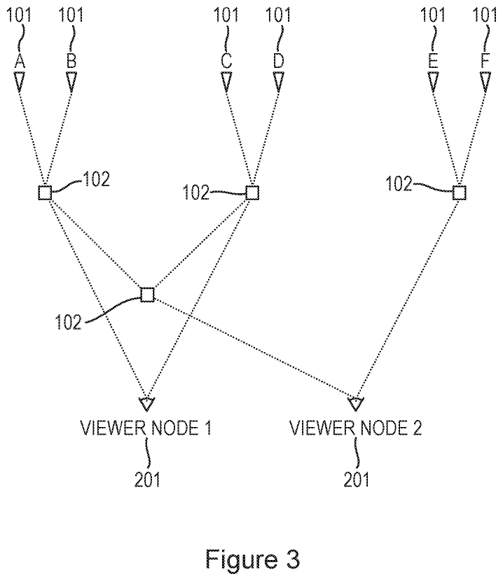

In FIGS. 2 and 3, parts of the network have 3 layers and parts of the network have 4 layers. The network comprises source nodes 101 which a leaf nodes of the network. The network comprises at least one viewer node 201 that is an end point of data pipelines through the network. One or more intermediate nodes 102 are provided between each source node and at least one viewer node 201.

The intermediate nodes that only receive data from one or more source nodes may be referred to as cluster nodes. Each cluster node may receive data from a plurality of source nodes. As shown in FIGS. 1, 2, 3 and 4, an arbitrary number of source nodes and/or viewer nodes may be deployed to observe a scene and/or provide view points. The source nodes are registered, so that their pose relative to the scene's coordinate frame is known. The source nodes are grouped into clusters of a subset of the source nodes. The source nodes in each cluster may send a stream of RGB-D images, comprising colour and depth channels, to a cluster node.

A viewer node may send a request to each intermediate node, including the cluster nodes, for a 3D data stream, such as an RGB-D image, corresponding to the view point of a viewer in the scene. The sent request may be referred to as a view point request. The requested data corresponds to the data stream that a source node would output if located at the view point defined by the view point request.

One or more of the cluster nodes may transmit a 3D data stream to the viewer node in response to the view point request. The transmitted 3D data stream may be transmitted via one or more other intermediate nodes. Each cluster node can only output data in dependence on the source nodes that it receives data from. There may therefore be blindspots in the transmitted data where parts of the requested viewpoint in the scene were not visible to the sensors of the cluster module.

Each intermediate node may be capable of outputting data at a comparable rate to its input data rate. Accordingly, each cluster node may receive inputs from N source nodes and output up to M virtual sensor streams. Each intermediate node may be a virtual depth sensor.

Within the viewer node the virtual sensor streams, that may be virtual RGB-D images, from one or more cluster nodes corresponding to the viewpoint request are combined and rendered. For example, they may be used to generate a 2D image display. This may be done using the depth image of each virtual depth sensor output to perform z-culling of occluded points in the scene.

To scale the network, one or more layers of intermediate nodes may be provided between the cluster nodes and viewer nodes. Each of these may receive 3D data streams, that may be virtual depth images, from other intermediate nodes, process the received data to generate a 3D data stream of a virtual depth image and output the virtual depth image to one or more viewer nodes or other intermediate nodes. As shown in FIGS. 2 and 3, by increasing the number of layers in the network, more viewer nodes and source nodes may be added to the network.

Each node may only be capable of receiving up to N input data streams. In order to be able to receive data from an arbitrary number or sources nodes and/or upstream intermediate nodes, an intermediate node may receive N input depth images and/or virtual depth images and output M virtual depth images, i.e. virtual sensor data streams. An intermediate node may receive data from N intermediate nodes in the previous layer this may be repeated for multiple layers, multiplying the number of nodes by N for each node layer. Eventually the node layer inputs are cluster nodes and sensor modules.

All computation occurs at the nodes processing input data streams such that new clusters of source nodes may be added to the network substantially without increasing the computational load on the rest of the networks nodes.

The data pipelines through the network may be agnostic to the specific type/make/model of 3D vision sensor, or other type of source node, as long as each data source outputs 3D point data about a scene which may be registered into a common coordinate system. The data pipelines may work with any 3D data stream source with the properties of such sensors, for example simulated or recorded 3D sensor data. In the case of RGB-D sensors the data consists of two 2D images from the sensor's point of view in the scene, one colour/intensity image and one depth image.

There may be more than 3 ‘colour’ channels in the 3D data stream representing different intensity quantities. For example, the RGB channels plus an infrared channel. This allows a viewer node to select from multiple different types of measured data by a source node.

Embodiments include a source node being a virtual sensor. This can be useful when, for example, a large point cloud or other 3D model is hosted at the sensor end of the network. Rather than laboriously transmit the entire model to all users, it can be more efficient to transmit one or more virtual depth images representing the part of the model that can actually be seen by one or more users.

The multiple source nodes that all transmit their data to the same cluster node may be combined in a physical unit, referred to as a source support unit. The source support unit may control the relative orientations between the source nodes in order to ensure effective coverage of a scene. The cluster node may be provided in the same source support unit as the source nodes that it receives data from.

The physical form of the network and its topology may vary depending on use case. The communication between nodes may be over wired or wireless channels.

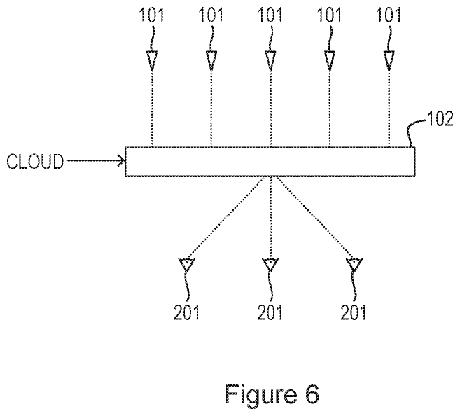

As shown in FIG. 6, embodiments include a cloud based system in which all the source nodes transmit their data stream to a cloud computing based central processing node that is able to receive data from a large number of source nodes and transmit data to an arbitrary number of viewer nodes.

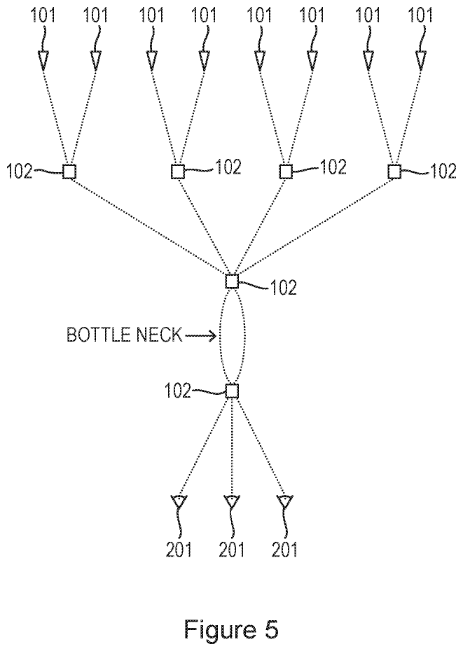

The network architecture of FIG. 5 may be used if there is a bottlenecked bandwidth between the source nodes and viewer nodes (e.g. of a single view).

In order to reduce data rates/bandwidth requirements as much as possible, the data streams themselves between nodes may be compressed. The 3D data streams may be compressed according to different compression/decompression schemes. Whilst the depth channels should be compressed losslessly, or with low loss to preserve depth resolution as much as possible, the colour channels may be compressed with lossy schemes leading to greater compression ratios. The compression/decompression scheme may be chosen to not significantly increase the latency beyond a desired amount which will depend on the application.

Embodiments may use known techniques for combining depth images and/or virtual depth images. For example, virtual depth images may be constructed by rendering 3D images into a 2D view while simultaneously maintaining a depth channel or z-buffer. When a new pixel is added to the virtual depth image, if its depth value is less than the current depth value for that pixel it overwrites the current pixel, but otherwise it is ignored. This is the well known rendering process called ‘z-buffering’.

Optionally, when one pixel occludes another in a primary virtual image, rather than discard the occluded pixel it can be retained to create multi-layer data. This can be achieved either by introducing additional channels in a single virtual sensor image, or by creating additional virtual sensor images, optionally imposing a limit on the number of additional channels or images created. The effect of multiple virtual image layers is to enable the user to see around or through the objects in the received virtual image. An advantage of this is that the viewer node is more tolerant to differences between its requested view point and the view of the virtual sensor they receive; this, in turn, means that the virtual sensor view may be updated much less frequently, saving on bandwidth.

Measured data 3D sensor data may comprise at least some noise. When comparing two pixels, rather than always overwrite with the nearest pixel, embodiments include replacing both pixels with weighted average value, where the weight varies with the depth of the observed pixels, with the nearest pixel having the highest weight and more distant pixels having a lower weight. Each node must decide when to transmit its data. Embodiments include using the timing of a received data frame to trigger transmission of a data frame by the node. For example, the received data frame with the highest framerate may be used, or one of the other received data frames may be used.

Alternatively, the transmission of data frames by each node may be triggered by a global clock message. This may be preferred for latency reduction because it may improve synchronisation across the system, and also allow some external control of the bandwidth requirements of the whole system by providing an option to speed up, or to slow down, the global transmission rate. When using global clocking, it is preferable for each receiving layer to be clocked after its transmitting layer so that it has just enough time to render all new data. This minimises end-to-end latency in multilayer systems.

Embodiments include the system comprising a controller that is arranged to transmit the global clock message to each of the source nodes and/or intermediate nodes. The controller may be one of the intermediate nodes, viewer nodes or source nodes.

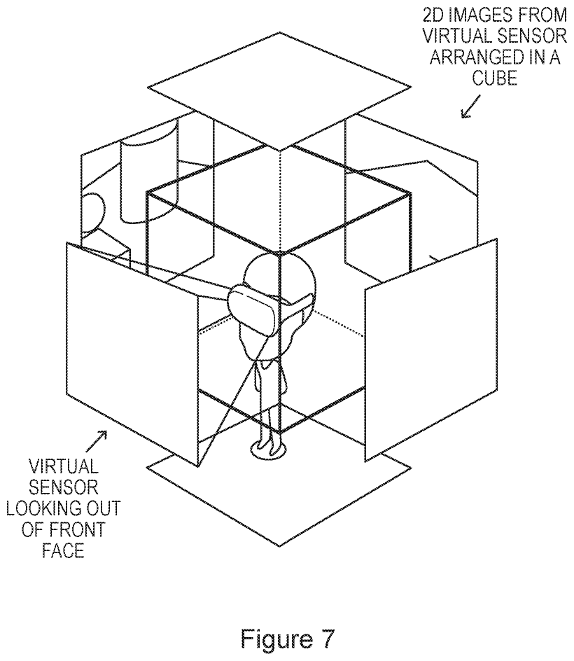

With regard to representing a viewpoint for VR Applications, it may not always be desirable to move each virtual sensor's view when the viewer moves since static viewpoints potentially allow data streams to compress well. Embodiments include using a sky cube, also referred to as cube mapping. To avoid re-computing a virtual sensor's view when the user looks around from the same spot, a sky cube may be used. As shown in FIG. 7, this may be made by combining the images from six cameras, each pointing in the direction of a different face of a cube. If these images are projected onto the corresponding faces of a cube, then from the point of view of an eye at the centre of the cube the effect is to give a full surround view meaning that the rotation of the viewer does not require rotation of any virtualised views. This technique means that it is possible to simply transmit 6 virtualised views, rather than having to recompute a new virtualised view every time the user moves their head. Embodiments include not transmitting all 6 faces and instead only transmitting the faces required given the viewer's current direction, i.e. view point. Rotations of the viewer do not require the cube's centre to change, however when the viewer moves a certain distance from the cube's centre then the cube must be recentred on the viewer's eye. This distance will depend on the size of the cube and the distances of points in the scene.

Embodiments include virtual depth images that comprise 2 or more depth channels. This allows some shadows/blindspots to be eliminated when a virtual reality view and virtual sensor view are misaligned. It also allow transparency of near objects in a scene so that a viewer can look through occluding objects from the same viewpoint.

In embodiments, each source node has a transmission bandwidth for transmitting a 3D data stream. The required bandwidth by each viewer node for receiving one or more 3D data streams may be substantially the same as, or less than, the transmission bandwidth of the source node with the largest transmission bandwidth.

In a system according embodiments the number of source nodes may be between 1 and 1000, the number of intermediate nodes may be between 1 and 1000, and the number of viewer nodes may be between 1 and 1000.

In the above-described embodiments, each source node generates a 3D data stream. The 3D data stream is unstructured data. In the present document, unstructured data refers to data which does not have a model to describe its form. Unstructured data is therefore fundamentally different from structured data. Structured data includes, for example, data for a CAD model and/or data for a geometric function. RGB-D data is an example of unstructured data. RGB-D data comprises a colour image and a depth map of a scene taken from the sensor's viewpoint in 3D space.

Embodiments provide a method for constructing 3D data streams that are used to generate specific viewpoints in a scene, for example the viewpoint of a single observer or the viewpoints of multiple observers. Each viewpoint is constructed directly from actual, or virtual, 3D sensor data streams without the intermediate step of a model being constructed. The ability to construct viewpoints without constructing a model reduces the computational requirements for the construction each view point. Embodiments provide a pipeline starting with a plurality of streams of unstructured 3D data (e.g. from sensors or simulated sensors taken from a viewpoint in space) which output data to a set of multiple computer processing nodes (which may be on a single or multiple machines connected in a network). Embodiments provide techniques for combining data from the pipeline of nodes to produce virtual 3D sensor views from an arbitrary viewpoint in 3D space which may then be displayed to an observer. Advantageously, the bandwidth and processing power capabilities of each node required to provide virtual 3D sensor views from an arbitrary viewpoint in 3D space are lower than with known techniques. The techniques of embodiments reduce the large processing and bandwidth capabilities required for displaying 3D data from a given viewpoint using an arbitrary number of input 3D data streams by sampling, processing, and transmitting only the required data in the 3D data streams for constructing a view from the viewpoint.

The techniques of embodiments are fundamentally different from, for example, methods in which a model of a virtual environment composed of structured data (e.g. mesh surface or other geometric models representing logical components) in whole, or part, is transmitted and then rendered to produce images from a given viewpoint. The application of structured data methods to the case of 3D sensing leads to inefficiencies. The logical unit of data is all the data coming from a single sensor, which may contain hundreds of objects and span a large physical area, then applying structured data techniques typically results in the transmission of all, or most, of the data when it may not be required. On the other hand, if the unit of data is a single point, then there are overwhelmingly many data units. This becomes inefficient to the extent of it being impractical to process all of the data as the number of sensors used in the system increases.

Embodiments are also fundamentally different from techniques that comprise the projection and stitching together of 2D images into panoramas. Embodiments also do not relate to the handling of projected 2D images or videos to make VR videos, in which a user wears a VR headset to view a VR video stream. Embodiments also do not relate to the display of virtual 3D objects in a camera.

Embodiments include a number of modifications and variations to the techniques described herein.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

Methods and processes described herein can be embodied as code (e.g., software code) and/or data. Such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system). It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), phase-change memory and magnetic and optical storage devices (hard drives, magnetic tape, CDs, DVDs); network devices; or other media now known or later developed that is capable of storing computer-readable information/data. Computer-readable media should not be construed or interpreted to include any propagating signals.

1. A system for generating a virtual view by each of one or more viewer nodes, the system comprising:
a plurality of source nodes, wherein each source node is a source of a 3D data stream and the 3D data stream is unstructured data;
a plurality of intermediate nodes, wherein each intermediate node is arranged to receive a 3D data stream from one or more of the source nodes and to generate a virtual 3D data stream in dependence on each received 3D data stream; and
one or more viewer nodes, wherein each viewer node is arranged to receive a virtual 3D data stream from each of one or more intermediate nodes and to generate a virtual view in dependence on each received virtual 3D data stream;
wherein each source node has a transmission bandwidth for transmitting a 3D data stream; and
the required bandwidth by each viewer node for receiving one or more 3D data streams is substantially the same as, or less than, the transmission bandwidth of the source node with the largest transmission bandwidth.

2. The system according to claim 1, wherein the system comprises a networked arrangement of one or more layers of intermediate nodes between a plurality of sources nodes and one or more viewer nodes.

3. The system according to any of claim 1 or 2, wherein at least one of the intermediate nodes is arranged to receive a virtual 3D data stream from each of a plurality of other intermediate nodes; and
said at least one of the intermediate nodes is arranged to generate and output a virtual data stream in dependence on a combination of the received virtual 3D data streams.

4. The system according to any preceding claim, wherein each source node comprises one or more of:
a 3D sensor that is arranged to generate a 3D data stream of substantial real-time data measurements;
a source of a simulated 3D data stream; and
a source of recorded 3D data stream.

5. The system according to any preceding claim, wherein each source node is a source of a 3D data stream that comprises 3D images;
and, optionally, the 3D images are RGB-D images.

6. The system according to any preceding claim, wherein:
the virtual 3D data stream generated by each intermediate node is a virtual depth image;
each virtual depth image includes at least one depth channel; and
each viewer node is arranged to generate a virtual view in dependence on a combination of virtual depth images received from a plurality of intermediate nodes;
wherein, optionally, each virtual depth image is a virtual RGB-D image.

7. The system according to claim 6, wherein:
the generation of a virtual view comprises performing a z-culling of occluded points; and
the virtual view is one or more of a 2D image display, a virtual reality display and data that may interpreted by a machine learning/artificial intelligence system, such as for image recognition techniques.

8. The system according to any preceding claim, wherein:
each viewer node is arranged to send a view point request to one or more intermediate nodes and/or one or more source nodes; and
each view point request is a request for data required for generating a virtual view;
wherein, optionally, each virtual depth image generated by an intermediate node is generated in response to a received view point request.

9. The system according to claim 7 or 8, wherein each virtual depth image generated by an intermediate node substantially only comprises data for use in generating a virtual view corresponding to a received view point request.

10. The system according to any preceding claim, wherein the system comprises a plurality of viewer nodes.

11. The system according to any preceding claim, wherein the system is scalable such that one or more source nodes, intermediate nodes and viewer nodes may be added to, or removed from, the system.

12. The system according to any preceding claim, wherein at least some of the intermediate nodes are provided in a cloud computing system.

13. The system according to any preceding claim, wherein the input bandwidth of each intermediate node is substantially the same as the output bandwidth of each intermediate node.

14. The system according to any preceding claim, wherein one or more of the source nodes and/or one or more of the intermediate nodes are arranged to compress 3D data streams prior to their transmission.

15. The system according to any preceding claim, the system further comprising a source support unit that is arranged to support a plurality of the source nodes; and
the relative geometry between said plurality of source nodes is dependent on the source support unit;
wherein, optionally, all of said plurality of source nodes are arranged to transmit a 3D data stream to the same intermediate node; and
wherein, optionally, the intermediate node that said plurality of sources nodes transmit a 3D data stream to is supported by the source support unit.

16. The system according to any preceding claim, the system further comprising a controller that is arranged to transmit a global clock message to each of the source nodes and/or intermediate nodes;
wherein the transmission of data from the source nodes and/or intermediate nodes is dependent on the global clock message.

17. The system according to claim 16, wherein the controller is one of the intermediate nodes.

18. The system according to any preceding claim, wherein, in response to a view point request from a viewer node, one or more of the intermediate nodes are arranged to transmit a plurality of virtual depth images to a viewer node; and
the plurality of transmitted virtual depth images are at least two sides of a sky cube.

19. The system according to any preceding claim, wherein:
the number of source nodes is between 1 and 1000; and/or
the number of intermediate nodes is between 1 and 1000.

20. The system according to any preceding claim, wherein the number of viewer nodes is between 1 and 1000.

21. The system according to any preceding claim, wherein the number of data streams input to one of the intermediate nodes is different from the number of data streams input to another one of the intermediate nodes.

22. A method of generating a virtual view by each of one or more viewer nodes, the method comprising:
generating, by each of a plurality of source nodes, a 3D data stream, wherein the 3D data stream is unstructured data;
receiving, by each of a plurality of intermediate nodes, a 3D data stream from one or more of the source nodes and generating a virtual 3D data stream in dependence on each received 3D data stream; and
receiving, by one or more viewer nodes, a virtual 3D data stream from each of one or more intermediate nodes and generating a virtual view in dependence on each received virtual 3D data stream;
wherein each source node has a transmission bandwidth for transmitting a 3D data stream; and
the required bandwidth by each viewer node for receiving one or more 3D data streams is substantially the same as, or less than, the transmission bandwidth of the source node with the largest transmission bandwidth.

23. The method according to claim 22, wherein the method is implemented in a system according to any of claims 1 to 21.

24. A computer program product that, when executed by a computing system, is arranged to cause the computing system to perform the method according to any of claim 22 or 23.
